(19) United States
(12) Patent Application Publication
(10) Pub. No.: US 2024/0276569 A1
(43) Pub. Date: Aug. 15, 2024

(54) METHOD AND APPARATUS FOR DATA EXCHANGE

(71) Applicant: Jingdong Technology Holding Co.,Ltd., Beijing (CN)

(72) Inventors: Xiangliang MENG, Beijing (CN); Qing WANG, Beijing (CN); Xin ZHANG, Beijing (CN)

(21) Appl. No.: 18/567,691

(22) PCT Filed: Apr. 13, 2022
(86) PCT No.: PCT/CN2022/086490

§ 371 Date: Dec. 6, 2023

(30) Foreign Application Priority Data
Jun. 23, 2021 (CN) 202110697338.7

(51) Int. Cl. H04W 76/14; G16Y 10/75; G16Y 20/40; G16Y 40/10; H04L 67/12; H04W 8/00

(52) U.S. Cl. CPC H04W 76/14; H04L 67/12; H04W 8/005; G16Y 10/75; G16Y 20/40; G16Y 40/10

(57) ABSTRACT

Embodiments of the present disclosure disclose a method and apparatus for data exchange. An embodiment comprises: in response to determining that a target device identifier of a target Bluetooth device is included in a device list, and in response to determining that a preset application protocol exists in the target Bluetooth device, establishing a Bluetooth transmission connection on the basis of the application protocol; acquiring a H5 module and configuration parameters corresponding to the target Bluetooth device; and on the basis of the configuration parameters, receiving data to be parsed that is sent by the target Bluetooth device, and transmitting said data to the H5 module by unvarnished transmission. The H5 module performs: parsing said data by using a parsing algorithm to obtain parsed data; and on the basis of the interface specification of an Internet of Things platform, sending the parsed data to the Internet of Things platform.

### CROSS-REFERENCE TO RELATED APPLICATIONS

This application claims priority to Chinese Patent Application No. 202110697338.7, entitled “Method and Apparatus for Data Exchange”, filed with the China National Intellectual Property Administration (CNIPA) on Jun. 23, 2021, the content of which is incorporated herein by reference in its entirety.

### TECHNICAL FIELD

Embodiments of the present disclosure relate to the field of computer technology, in particular to the field of Internet of Things technology, and more particularly, to a method and apparatus for data interaction.

### BACKGROUND

Bluetooth transmission, as an important technical direction of Internet of Things, is widely used in wearable devices, health instruments, smart homes and other fields. An IoT platform may provide connection interfaces for Bluetooth devices, and provide a set of application protocols of the IoT platform to support the accesses of the Bluetooth devices, which may include, for example, device discovery, activation binding, security authentication, data transmission, protocol encryption, and other Bluetooth device access protocols.

### SUMMARY

Embodiments of the present disclosure propose a method and apparatus for data interaction.

In a first aspect, embodiments of the present disclosure provide a method for data interaction, the method including: extracting, in response to a broadcast packet sent by a target Bluetooth device, from the broadcast packet a target device identifier of the target Bluetooth device; retrieving the target device identifier in a preset device list, the device list including device identifiers of connectable Bluetooth devices; in response to determining that the target device identifier is included in the device list, determining whether a preset application protocol exists in the target Bluetooth device; in response to determining that the preset application protocol exists in the target Bluetooth device, establishing a Bluetooth transmission connection based on the application protocol; acquiring, based on the target device identifier, a H5 module and configuration parameters corresponding to the target Bluetooth device, the H5 module being pre-set with an interface specification of an IoT platform and a parsing algorithm preset by a manufacturer, and the configuration parameters characterizing parameters of the preset application protocol pre-determined by the manufacturer; receiving, based on the configuration parameters, to-be-parsed data sent by the target Bluetooth device, and transmitting the to-be-parsed data to the H5 module by unvarnished transmission; and performing following steps through the H5 module: parsing the to-be-parsed data using the parsing algorithm to obtain parsed data; and sending the parsed data to the IoT platform based on the interface specification of the IoT platform.

In some embodiments, the method further comprises: in response to determining that the preset application protocol does not exist in the target Bluetooth device, acquiring an application protocol of the IoT platform; and sending the application protocol of the IoT platform to the target Bluetooth device, and establishing a Bluetooth transmission connection based on the application protocol of the IoT platform.

In some embodiments, the H5 module and the configuration parameters are acquired via following steps: sending the target device identifier to a server of the IoT platform, to instruct the server to determine the H5 module and the configuration parameters corresponding to the target device identifier based on a preset corresponding relationship between the device identifier and the H5 module and the configuration parameters; and receiving the H5 module and the configuration parameters sent by the server.

In some embodiments, the H5 module further comprises an interface specification of a manufacturer server of the manufacturer, and a data processing algorithm is pre-provided in the manufacturer server; and the method further comprises performing following steps through the H5 module: sending the parsed data to the manufacturer server based on the interface specification of the manufacturer server, to instruct the manufacturer server to call the data processing algorithm to process the parsed data; receiving processed data sent by the manufacturer server; and sending the processed data to the IoT platform.

In some embodiments, the configuration parameters comprise a device access mode; and the method further comprises performing following steps through the H5 module: in response to determining that the device access mode is a connection-oriented access mode, receiving downlink data sent by the IoT platform, and transmitting the downlink data to the Bluetooth device.

According to a second aspect, some embodiments of the present disclosure provide an apparatus for data interaction. The apparatus includes: a device discovery unit, configured to extract, in response to a broadcast packet sent by a target Bluetooth device, from the broadcast packet a target device identifier of the target Bluetooth device; a list retrieving unit, configured to retrieve the target device identifier in a preset device list, the device list comprising device identifiers of connectable Bluetooth devices; a protocol detection unit, configured to determine whether a preset application protocol exists in the target Bluetooth device, in response to determining that the target device identifier is included in the device list; a connection establishing unit, configured to establish a Bluetooth transmission connection based on the application protocol, in response to determining that the preset application protocol exists in the target Bluetooth device; an information acquisition unit, configured to acquire, based on the target device identifier, a H5 module and configuration parameters corresponding to the target Bluetooth device, the H5 module being pre-set with an interface specification of an IoT platform and a parsing algorithm preset by a manufacturer, and the configuration parameters characterizing parameters of the preset application protocol pre-determined by the manufacturer; a data transmission unit, configured to receive, based on the configuration parameters, to-be-parsed data sent by the target Bluetooth device, and transmit the to-be-parsed data to the H5 module by unvarnished transmission; and a data interaction unit, configured to perform following steps through the H5 module: parsing the to-be-parsed data using the parsing algorithm to obtain parsed data; and sending the parsed data to the IoT platform based on the interface specification of the IoT platform.

In some embodiments, the connection establishing unit further includes: a protocol acquisition module, configured to acquire an application protocol of the IoT platform, in response to determining that the preset application protocol does not exist in the target Bluetooth device; and a protocol sending module, configured to send the application protocol of the IoT platform to the target Bluetooth device, and establish a Bluetooth transmission connection based on the application protocol of the IoT platform.

In some embodiments, the information acquisition unit further comprises: a device identifier sending module, configured to send the target device identifier to a server of the IoT platform, to instruct the server to determine the H5 module and the configuration parameters corresponding to the target device identifier based on a preset corresponding relationship between the device identifier and the H5 module and the configuration parameters; and an information receiving module, configured to receive the H5 module and the configuration parameters sent by the server.

In some embodiments, the H5 module further comprises an interface specification of a manufacturer server of the manufacturer, and a data processing algorithm is pre-provided in the manufacturer server; and the data processing unit is further configured to perform following steps through the H5 module: sending the parsed data to the manufacturer server based on the interface specification of the manufacturer server, to instruct the manufacturer server to call the data processing algorithm to process the parsed data; receiving processed data sent by the manufacturer server; and sending the processed data to the IoT platform.

In some embodiments, the configuration parameters comprise a device access mode; the data processing unit is further configured to perform following steps through the H5 module: in response to determining that the device access mode is a connection-oriented access mode, receiving downlink data sent by the IoT platform, and transmitting the downlink data to the Bluetooth device.

According to a third aspect, some embodiments of the present disclosure provide an electronic device, the electronic device comprises: one or more processors; and a storage apparatus, storing one or more programs thereon, the one or more programs, when executed by the one or more processors, cause the one or more processors to implement the method for data interaction according to the first aspect.

According to a fourth aspect, some embodiments of the present disclosure provide a computer readable medium, storing a computer program thereon, where, the program, when executed by a processor, implements the method for data interaction according to the first aspect.

### BRIEF DESCRIPTION OF THE DRAWINGS

Other features, objectives and advantages of the present disclosure will become more apparent, by reading detailed description of non-limiting embodiments with reference to the following accompanying drawings:

FIG. 1 is an example system architecture diagram to which some embodiments of the present disclosure may be applied;

FIG. 2 is a flowchart of a method for data interaction according to an embodiment of the present disclosure;

FIG. 3 is a schematic diagram of a scenario of an embodiment of the method for data interaction shown in FIG. 2;

FIG. 4 is a signaling diagram of a method for data interaction according to an embodiment of the present disclosure;

FIG. 5 is a schematic structural diagram of an apparatus for data interaction according to an embodiment of the present disclosure; and

FIG. 6 is a schematic structural diagram of an electronic device suitable for implementing embodiments of the present disclosure.

### DETAILED DESCRIPTION OF EMBODIMENTS

Embodiments of the present disclosure are described in further detail below in connection with the accompanying drawings. It may be understood that embodiments described herein are only for the purpose of explaining the relevant disclosure, and are not a limitation of the disclosure. It should also be noted that, for ease of description, only parts related to the relevant disclosure are shown in the accompanying drawings.

It should be noted that embodiments and features in the embodiments in the present disclosure may be combined with each other on a non-conflict basis. Embodiments of the present disclosure will be described in detail below with reference to the accompanying drawings.

In related technologies, manufacturer of a Bluetooth device often pre-sets customized application protocol in the Bluetooth device it produces. When such a Bluetooth device is connected to an IoT platform provided by another service provider, due to the limitations of resources, broadcast packets, and power consumption on the Bluetooth device side, it is not possible to support both the manufacturers' customized application protocol and an application protocol provided by the IoT platform, and it is necessary for the Bluetooth device to give up the manufacturer's customized application protocol or to support both of the application protocols at the same time.

Embodiments of the present disclosure provide a method and apparatus for data interaction, when a Bluetooth device sends a broadcast packet, a device identifier of the Bluetooth device is extracted from the broadcast packet, and it is determined whether the Bluetooth device satisfies a connection condition based on the device identifier. When it is determined that the Bluetooth device satisfies the connection condition, a H5 module and configuration parameters corresponding to the Bluetooth device are acquired, and if a preset application protocol exists in the Bluetooth device, a Bluetooth transmission connection is established based on the preset application protocol in the Bluetooth device, in order to receive to-be-parsed data sent by the Bluetooth device and transmit the to-be-parsed data to the H5 module that is pre-implemented by a manufacturer, where the H5 module parses the to-be-parsed data and sends the parsed data to an IoT platform. There is no need to force the Bluetooth device to support an application protocol provided by the IoT platform to realize the connection between the Bluetooth device and the IoT platform, so that data interaction between the Bluetooth device and the IoT platform may be realized, which may improve the efficiency and convenience of the connection between the Bluetooth device and the IoT platform.

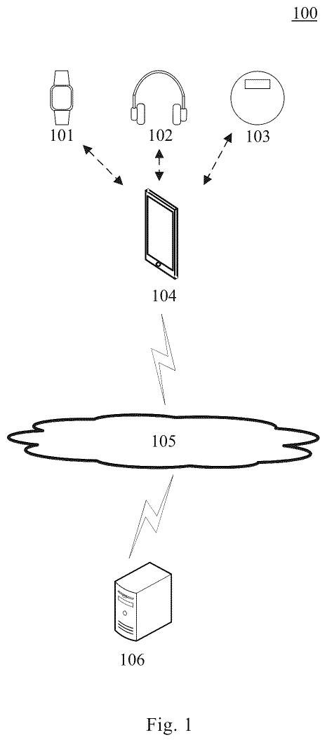

FIG. 1 illustrates an example system architecture 100 of a method for data interaction or an apparatus for data interaction to which embodiments of the present disclosure may be applied.

As shown in FIG. 1, the system architecture 100 may include Bluetooth device(s) 101, 102, 103, a terminal device 104, a network 105, and a server 105. Bluetooth communication module(s) is provided in the Bluetooth device(s) 101, 102, 103 as well as in the terminal device 104, so that the Bluetooth device(s) 101, 102, 103 and the terminal device 104 may be connected through Bluetooth connection, for example, the Bluetooth device(s) 101, 102, 103 may send broadcast packets and to-be-parsed data to the terminal device 104, and the terminal device 104 may parse the to-be-parsed data to obtain the parsed data.

The network 104 serves to provide a medium of communication links between the terminal device 104 and the server 105. The network 104 may include various connection types, such as wired, wireless communication links or optic fibers. The terminal device 14 communicates with the server 106 via the network 105 to send parsed data to the server 106.

The Bluetooth device(s) 101, 102, 103 may be electronic device(s) having Bluetooth communication function(s), including, but not limited to, wearable devices (e.g., smart bracelet 101, headphone 102), health detection devices (e.g., weight meter 103), or the like.

The server 106 may be a server of an IoT platform, and may allow accesses from Bluetooth devices of different manufacturers to acquire data from the Bluetooth devices and provide services to users based on the acquired data. It should be noted that the server may be hardware or software. When the server is hardware, it may be implemented as a distributed server cluster composed of a plurality of servers, or as a single server. When the server is software, it may be implemented as a plurality of software or software modules (for example, for providing distributed services) or as a single software or software module.

It should be noted that the method for data interaction provided by embodiments of the present disclosure may be performed by the terminal device 104, correspondingly, the apparatus for data interaction may be provided in the terminal device 104.

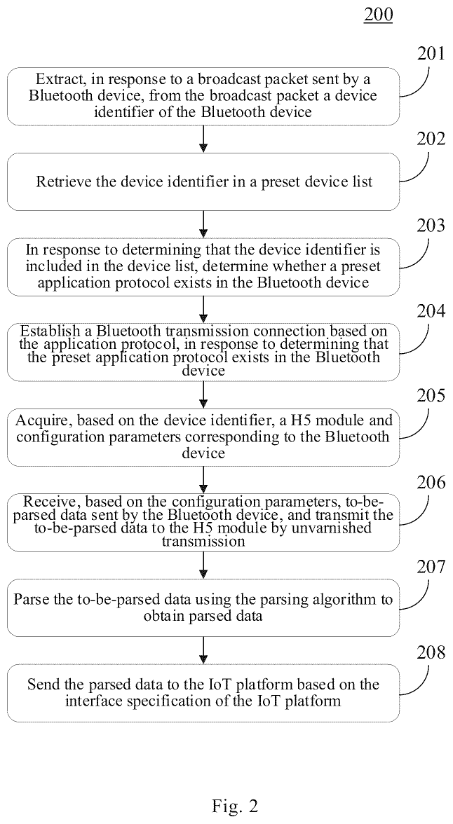

With further reference to FIG. 2, illustrating a flow 200 of a method for data interaction according to an embodiment of the present disclosure. The method for data interaction includes the following steps:

Step 201, extracting, in response to a broadcast packet sent by a Bluetooth device, from the broadcast packet a device identifier of the Bluetooth device.

Typically, a Bluetooth device uses a built-in Bluetooth module to send broadcast packet(s) outward, and the broadcast packet includes the device identifier used to characterize an identity of the Bluetooth device. The device identifier may be, for example, a device name, a device ID (Identity document), or UUID (Universally Unique Identifier). When another device receives the broadcast packet, it may extract the device identifier of the Bluetooth device therefrom and use it for device discovery.

In the present embodiment, an executing body may be the terminal device as shown in FIG. 1, for example, the terminal device may be a smartphone, which may be equipped with a Bluetooth module and a client end of the IoT platform. The executing body calls the Bluetooth module on the backend via the client end to receive the broadcast packet of the to-be-connected Bluetooth device.

In a detailed example, the manufacturer of the Bluetooth device may pre-configure parameters of its Bluetooth device in a manufacturer-oriented developer center of the IoT platform, the parameters may include, for example, an offset address of field ADType=0xFF in the broadcast packet. Then, the IoT platform issues the parameters to the client end equipped in the executing body. In this way, when the executing body receives the broadcast packet of the Bluetooth device, it may extract the device identifier of the Bluetooth device based on the offset address.

It should be noted that if the executing body is unable to extract the device identifier of the Bluetooth device from the broadcast packet, it indicates that the Bluetooth device is not a legitimate access device of the IoT platform, and the Bluetooth device is not applicable to the method for data interaction provided in embodiments of the present disclosure.

Step 202, retrieving the device identifier in a preset device list.

In the present embodiment, the device list includes device identifiers of connectable Bluetooth devices. As an example, the manufacturer of the Bluetooth device may pre-register the device identifier of the Bluetooth device in the manufacturer-oriented developer center of the IoT platform, and the device identifier is unique across products. Then, the IoT platform adds the device identifier of the Bluetooth device to the device list and sends the device list to the executing body, so that the executing body may determine whether the Bluetooth device that sends the broadcast packet in step 201 is a legitimate access device of the IoT platform by retrieving the device list, and filter out Bluetooth devices that do not exist in the device list.

Step 203, in response to determining that the device identifier is included in the device list, determining whether a preset application protocol exists in the Bluetooth device.

In the present embodiment, that the device identifier of the Bluetooth device is included in the device list indicates that the Bluetooth device is a legitimate access device of the IoT platform. As an example, the executing body may parse the broadcast packet received in step 201 to determine whether the preset application protocol is included in the Bluetooth device.

The application protocol in the present embodiment is also referred to as a profile, profile or configuration file, and the preset application protocol in the Bluetooth device represents a set of protocols customized by the manufacturer of the Bluetooth device based on application scenarios of the Bluetooth device, which may include various types of protocol stacks as a means of limiting various functions of the Bluetooth device. For example, the connection and broadcasting functions of the Bluetooth device may be controlled via GAP (Generic Access Profile) to make the Bluetooth device discoverable by other devices and to limit whether and how the Bluetooth device can interact with other devices. As a further example, the application protocol may also include a protocol stack corresponding to data transmission and protocol security.

Step 204, in response to determining that the preset application protocol exists in the Bluetooth device, establishing a Bluetooth transmission connection based on the application protocol.

Typically, the application protocol of the Bluetooth device includes GATT (Generic Attribute Profile), which is a generic specification for sending and receiving very short segments of data over a Bluetooth transmission connection. These short segments of data are referred to as attributes, and are used by the Bluetooth device to limit the Bluetooth device's connection to other devices.

As an example, the executing body may establish the Bluetooth transmission connection between the executing body and the Bluetooth device based on the GATT in the preset application protocol in the Bluetooth device, which may be, for example, BLE (Bluetooth Low Energy).

In some alternative implementations of the present embodiment, the method further includes: acquiring an application protocol of the IoT platform, in response to determining that the preset application protocol does not exist in the Bluetooth device; and sending the application protocol of the IoT platform to the Bluetooth device, and establishing the Bluetooth transmission connection based on the application protocol of the IoT platform.

In this implementation, the application protocol of the IoT platform is an application protocol customized by a service provider of the IoT platform, which may be pre-stored in the executing body. When the executing body detects that the Bluetooth device does not have the application protocol preset by the manufacturer, the application protocol of the IoT platform may be sent to the Bluetooth device and the Bluetooth transmission connection may be established based on the application protocol of the IoT platform. In this way, the Bluetooth device that does not have the preset application protocol may also establish a Bluetooth transmission connection between the Bluetooth device and the terminal device.

Step 205, acquiring a H5 module and configuration parameters corresponding to the Bluetooth device, based on the device identifier.

In the present embodiment, the H5 module is pre-set with an interface specification of the IoT platform and a parsing algorithm pre-set by the manufacturer, and the configuration parameters characterize parameters of the application protocol pre-determined by the manufacturer. The H5 module is a plug-in constructed by the manufacturer based on HTML5 standard, for data interaction with the IoT platform based on the interface specification of the IoT platform, and for parsing to-be-parsed data.

The configuration parameters are used to ensure that data may be transmitted between the executing body and the Bluetooth device via the Bluetooth transmission connection established in step 204. The configuration parameters may include, for example, a type and structure of the data uploaded by the Bluetooth device, and a connection mode for accessing the IoT platform, etc., and may also include a device ID length, big-endian/little-endian, and an offset address of the field ADType=0xFF.

In a detailed example, the manufacturer may upload the pre-constructed H5 module and the configuration parameters to the IoT platform, then the IoT platform may generate a corresponding relationship list between the H5 module, the configuration parameters, and the device identifier of the Bluetooth device, and send the corresponding relationship list to the executing body. Then, the executing body may call the corresponding relationship list from a local storage space, and retrieve in the corresponding relationship list based on the device identifier extracted in step 201, and determine the H5 module and the configuration parameters corresponding to the device identifier.

In some alternative implementations of the present embodiment, the H5 module and the configuration parameters may be acquired via the following steps: sending the device identifier to a server of the IoT platform, to instruct the server to determine the H5 module and the configuration parameters corresponding to the device identifier based on a preset corresponding relationship between the device identifier and the H5 module and the configuration parameters; and receiving the H5 module and the configuration parameters sent by the server.

In this implementation, the corresponding relationship between the device identifier and the H5 module and the configuration parameters may be stored in the cloud, and the terminal device may pull the H5 module and the configuration parameters corresponding to the device identifier from the cloud, which may reduce a storage load of the terminal device.

Step 206, receiving, based on the configuration parameters, to-be-parsed data sent by the Bluetooth device, and transmitting the to-be-parsed data to the H5 module by unvarnished transmission.

In the present embodiment, the executing body may receive the to-be-parsed data sent by the Bluetooth device through the Bluetooth transmission connection established in step 204, and transmit the received to-be-parsed data to the H5 module by unvarnished transmission.

In a detailed example, the Bluetooth device may be a weight meter, the executing body is a smartphone of a user, and the smartphone may be loaded with the client end of the IoT platform. The weight meter uses a built-in Bluetooth module to encode weight data and send the encoded data to the smartphone of the user, after the smartphone receives the encoded data as the to-be-parsed data, the client end does not perform a parsing operation on the to-be-parsed data, but directly transmits the to-be-parsed data to the H5 module by unvarnished transmission.

Then, the executing body may perform the following steps through the H5 module:

Step 207, parsing the to-be-parsed data using the parsing algorithm to obtain parsed data.

The parsing algorithm in the H5 module is generated by the manufacturer based on the application protocol of the Bluetooth device, so that the parsing step on the to-be-parsed data may be achieved by the H5 module.

Step 208, sending the parsed data to the IoT platform based on the interface specification of the IoT platform.

In the present embodiment, the executing body may construct a Bluetooth transmission connection between the client end of the IoT platform and the Bluetooth device based on the preset application protocol in the Bluetooth device, and the client end is only used to receive the to-be-parsed data from the Bluetooth device, while the parsing and sending of the data is achieved by the H5 module.

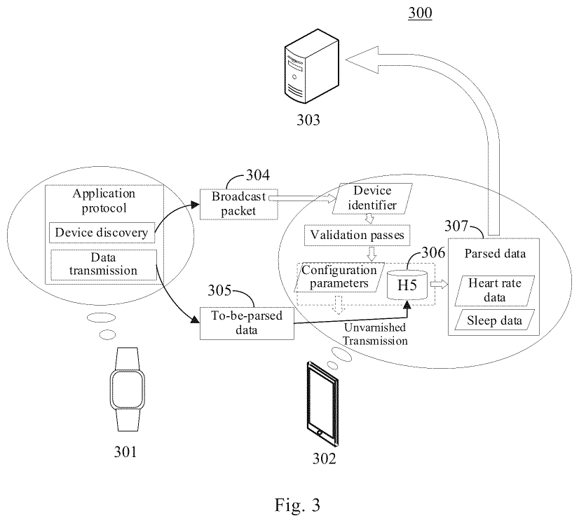

With further reference to FIG. 3, FIG. 3 is a schematic diagram of a scenario of an embodiment of the method shown in FIG. 2. In FIG. 3, a Bluetooth device 301 is a smart bracelet that may monitor a user's physiological data, such as sleep condition, or heart rate data, and the Bluetooth module included therein is preset with a manufacturer's customized application protocol. An executing body 302 is a smartphone with a client end of an IoT platform loaded thereon. A server 303 is a server of the IoT platform. When the user needs to acquire services of the IoT platform, the user may switch on the client end of the IoT platform on the smartphone and then bring the smart bracelet close to the smartphone. The smart bracelet sends a broadcast packet 304 based on the application protocol preset by the manufacturer, after the smartphone receives the broadcast packet, the smartphone extracts a device identifier of the smart bracelet therefrom, and then retrieves whether the device identifier is included in a device list, if yes, the validation passes. Then, the smartphone may acquire an H5 module 306 and configuration parameters corresponding to the device identifier, and then receive to-be-parsed data 305 sent by the smart bracelet based on the configuration parameters, where the to-be-parsed data is generated by encoding the collected physiological data by the smart bracelet based on the application protocol. Then, the smartphone transmits the to-be-parsed data to the H5 module by unvarnished transmission. The H5 module parses the to-be-parsed data by using a parsing algorithm preset by the manufacturer, to obtain parsed data 307, which may include, for example, the heart rate data and sleep data. Finally, the H5 module sends the parsed data to the server 303, thereby completing the connection between the smart bracelet and the IoT platform.

The method and apparatus for data interaction provided by embodiments of the present disclosure, when a Bluetooth device sends a broadcast packet, a device identifier of the Bluetooth device is extracted from the broadcast packet, and then whether the Bluetooth device satisfies a connection condition is determined based on the device identifier. When it is determined that the Bluetooth device satisfies the connection condition, a H5 module and configuration parameters corresponding to the Bluetooth device are acquired, then if a preset application protocol exists in the Bluetooth device, a Bluetooth transmission connection is established based on the preset application protocol in the Bluetooth device, in order to receive to-be-parsed data sent by the Bluetooth device and transmit the to-be-parsed data to the H5 module that is pre-implemented by a manufacturer, where the H5 module parses the to-be-parsed data and sends the parsed data to an IoT platform. There is no need to force the Bluetooth device to support an application protocol provided by the IoT platform, for realizing the connection between the Bluetooth device and the IoT platform, so that data interaction between the Bluetooth device and the IoT platform may be realized, which may improve the efficiency and convenience of the connection between the Bluetooth device and the IoT platform.

In some alternative implementations of the above embodiment, the H5 module further includes an interface specification of a manufacturer server, and a data processing algorithm is pre-provided in the manufacturer server; and, the method further includes performing the following steps through the H5 module: sending the parsed data to the manufacturer server based on the interface specification of the manufacturer server, to instruct the manufacturer server to call the data processing algorithm to process the parsed data; receiving processed data sent by the manufacturer server; and sending the processed data to the IoT platform.

In this implementation, the H5 module may also call the data processing algorithm of the manufacturer in the cloud, may process the parsed data according to the manufacturer's customized data processing strategy, and send the processed data to the IoT platform. It solves the limitation of power consumption and storage space of the Bluetooth device on data processing capability, improves the capability and flexibility of processing data of the Bluetooth device, and is especially suitable for more complex scenarios involving the processing of Bluetooth data.

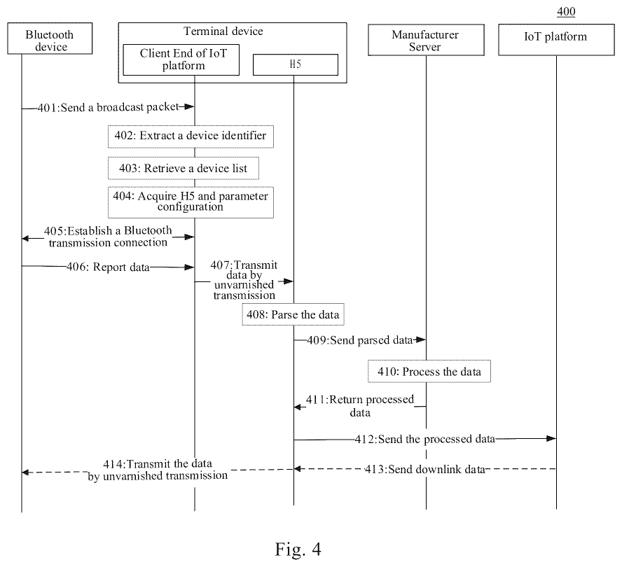

With further reference to FIG. 4, illustrating a signaling diagram 400 of an embodiment of the method for data interaction. The signaling diagram includes the following steps:

Step 401: A Bluetooth device sends a broadcast packet.

Here, the Bluetooth device may be based on a preset application protocol.

Step 402: A client end of an IoT platform loaded on a terminal device extracts, from the broadcast packet, a device identifier of the Bluetooth device.

Step 403: The client end retrieves in a device list.

Step 404: Acquiring H5 and parameter configuration.

Step 405: Establishing a Bluetooth transmission connection.

Step 406: The Bluetooth device reports data to the client end, the data being to-be-parsed data.

Step 407: The client end transmits the to-be-parsed data to H5 by unvarnished transmission.

Step 408: H5 parses the data.

Step 409: H5 sends parsed data to the manufacturer server.

Step 410: The manufacturer server calls a preset algorithm to process the parsed data.

Step 411: The manufacturer server returns processed data to H5.

Step 412: H5 sends the processed data to the IoT platform.

Step 401 to step 412 in the present embodiment correspond to step 201 to step 208 in the preceding text, detailed description thereof will be omitted herein.

In some alternative implementations of the present embodiment, the configuration parameters include a device access mode; and, when the access mode of the Bluetooth device is a connection-oriented access mode, the method further includes the following steps:

Step 413: The IoT platform sends downlink data to H5.

Step 414: H5 transmits the downlink data to the Bluetooth device by unvarnished transmission.

When the access mode of the Bluetooth device is a broadcast-oriented access mode, the data interaction process between the Bluetooth device and the terminal device only includes undirectional transmission from the Bluetooth device to the terminal device. When the access mode of the Bluetooth device is a connection-oriented access mode, the Bluetooth device may also receive data sent by the terminal device, i.e., a bidirectional transmission between the Bluetooth device and the IoT platform is realized.

As can be seen from FIG. 4, the embodiment shown in FIG. 4 embodies the step of the H5 module calling the data processing algorithm set by the manufacturer in the cloud to process the parsed data, which solves the limitation of power consumption and storage space of the Bluetooth device on data processing capability, improves the capability and flexibility of processing Bluetooth data, and is especially suitable for more complex scenarios involving the processing of Bluetooth data.

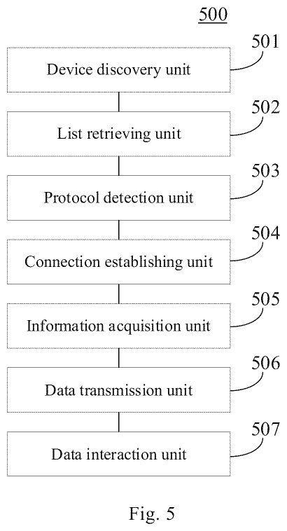

With further reference to FIG. 5, as an implementation of the method shown in the above figures, an embodiment of the present disclosure provides an apparatus for data interaction. The apparatus embodiment corresponds to the method embodiment as shown in FIG. 2. The apparatus may be applied to various electronic devices.

As shown in FIG. 5, an apparatus 500 for data interaction in the present embodiment includes: a device discovery unit 501, configured to extract, in response to a broadcast packet sent by a Bluetooth device, from the broadcast packet a device identifier of the Bluetooth device; a list retrieving unit 502, configured to retrieve the device identifier in a preset device list, the device list including device identifiers of connectable Bluetooth devices; a protocol detection unit 503, configured to determine whether a preset application protocol exists in the Bluetooth device, in response to determining that the device identifier is included in the device list; a connection establishing unit 504, configured to establish a Bluetooth transmission connection based on the application 1.0 protocol, in response to determining that the preset application protocol exists in the Bluetooth device; an information acquisition unit 505, configured to acquire, based on the target device identifier, a H5 module and configuration parameters corresponding to the Bluetooth device, the H5 module being pre-set with an interface specification of an IoT platform and a parsing algorithm preset by a manufacturer, and the configuration parameters characterizing parameters of the application protocol pre-determined by the manufacturer; a data transmission unit 506, configured to receive, based on the configuration parameters, to-be-parsed data sent by the Bluetooth device, and transmit the to-be-parsed data to the H5 module by unvarnished transmission; and a data interaction unit 507, configured to perform following steps through the H5 module: parsing the to-be-parsed data using the parsing algorithm to obtain parsed data; and sending the parsed data to the IoT platform based on the interface specification of the IoT platform.

In the present embodiment, the connection establishing unit 504 further includes: a protocol acquisition module, configured to acquire an application protocol of the IoT platform, in response to determining that the preset application protocol does not exist in the Bluetooth device; and a protocol sending module, configured to send the application protocol of the IoT platform to the Bluetooth device, and establish a Bluetooth transmission connection based on the application protocol of the IoT platform.

In the present embodiment, the information acquisition unit 505 further includes: a device identifier sending module, configured to send the device identifier to a server of the IoT platform, to instruct the server to determine the H5 module and the configuration parameters corresponding to the device identifier based on a preset corresponding relationship between the device identifier and the H5 module and the configuration parameters; and an information receiving module, configured to receive the H5 module and the configuration parameters sent by the server.

In the present embodiment, the H5 module further includes an interface specification of a manufacturer server of the manufacturer, and a data processing algorithm is pre-provided in the manufacturer server; and the data processing unit 507 is further configured to perform following steps through the H5 module: sending the parsed data to the manufacturer server based on the interface specification of the manufacturer server, to instruct the manufacturer server to call the data processing algorithm to process the parsed data; receiving processed data sent by the manufacturer server; and sending the processed data to the IoT platform.

In the present embodiment, the configuration parameters include a device access mode; and the data processing unit 507 is further configured to perform following steps through the H5 module: in response to determining that the device access mode is a connection-oriented access mode, receiving downlink data sent by the IoT platform, and transmitting the downlink data to the Bluetooth device.

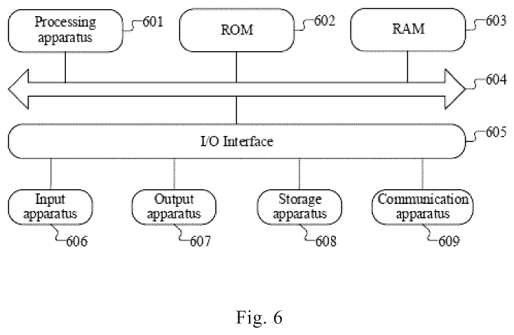

With further reference to FIG. 6, illustrating a schematic structural diagram of an electronic device (e.g., the server or terminal device in FIG. 1) 600 suitable for implementing embodiments of the present disclosure. The terminal device in embodiments of the present disclosure may include, but is not limited to, a mobile terminal such as mobile telephone, laptop computer, digital broadcast receiver, PDA (personal digital assistant), or PAD (tablet computer), and a fixed terminal such as a digital TV, or a desktop computer. The terminal device shown in FIG. 6 is merely an example and should not impose any limitation on the functions and scope of use of the embodiments of the present disclosure.

As shown in FIG. 6, the electronic device 600 may include a processing apparatus (for example, a central processing unit, a graphics processor, etc.) 601, which may execute various appropriate actions and processes in accordance with a program stored in a read-only memory (ROM) 602 or a program loaded into a random access memory (RAM) 603 from a storage apparatus 608. In the RAM 603, various programs and data required for the operation of the electronic device 600 are also stored. The processing apparatus 601, the ROM 602, and the RAM 603 are connected to each other through a bus 604. An input/output (I/O)) interface 605 is also connected to the bus 604.

Typically, the following apparatuses may be connected to the I/O interface 605; an input apparatus 606 including such as a touch screen, a touch pad, a keyboard, a mouse, a camera, a microphone, an accelerometer, or a gyroscope; an output apparatus 607 including such as a liquid crystal display (LCD), a speaker, a vibrator; the storage apparatus 608 including such as a magnetic tape, a hard disk; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all the illustrated apparatuses. It may alternatively be implemented or provided with more or fewer apparatuses. Each block shown in FIG. 6 may represent one apparatus, or may represent a plurality of apparatuses as needed.

In particular, according to embodiments of the present disclosure, the process described above with reference to the flow chart may be implemented in a computer software program. For example, an embodiment of the present disclosure includes a computer program product, which comprises a computer program that is hosted in a machine-readable medium. The computer program comprises program codes for executing the method as illustrated in the flow chart. In such an embodiment, the computer program may be downloaded and installed from a network via the communication portion 609, or may be installed from the storage portion 608, or may be installed from the ROM 602. The computer program, when executed by the central processing unit (CPU) 601, implements the above mentioned functionalities as defined by the methods of the present disclosure. It should be noted that the computer readable medium in embodiments of the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In some embodiments of the present disclosure, the computer readable storage medium may be any tangible medium containing or storing programs which can be used by a command execution system, apparatus or element or incorporated thereto. In some embodiments of the present disclosure, the computer readable signal medium may include data signal in the base band or propagating as parts of a carrier, in which computer readable program codes are carried. The propagating signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The above computer readable medium may be included in the electronic device, or a stand-alone computer readable medium not assembled into the electronic device. The computer readable medium carries one or more programs. The one or more programs, when executed by the electronic device, cause the electronic device to: extract, in response to a broadcast packet sent by a Bluetooth device, from the broadcast packet a device identifier of the Bluetooth device; retrieve the device identifier in a preset device list, the device list including device identifiers of connectable Bluetooth devices; in response to determining that the device identifier is included in the device list, determine whether a preset application protocol exists in the target Bluetooth device; in response to determining that the preset application protocol exists in the Bluetooth device, establish a Bluetooth transmission connection based on the application protocol; acquire, based on the target device identifier, a H5 module and configuration parameters corresponding to the Bluetooth device, the H5 module being pre-set with an interface specification of an IoT platform and a parsing algorithm preset by a manufacturer, and the configuration parameters characterizing parameters of the application protocol pre-determined by the manufacturer; receive, based on the configuration parameters, to-be-parsed data sent by the Bluetooth device, and transmit the to-be-parsed data to the H5 module by unvarnished transmission; and perform following steps through the H5 module: parsing the to-be-parsed data using the parsing algorithm to obtain parsed data; and sending the parsed data to the IoT platform, based on the interface specification of the IoT platform.

A computer program code for executing operations in some embodiments of the present disclosure may be compiled using one or more programming languages or combinations thereof. The programming languages include object-oriented programming languages, such as Java, Smalltalk or C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or server. In the circumstance involving a remote computer, the remote computer may be connected to a user's computer through any network, including local area network (LAN) or wide area network (WAN), or may be connected to an external computer (for example, connected through Internet using an Internet service provider).

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The units involved in the embodiments of the present disclosure may be implemented by means of software or hardware. The described units may also be provided in a processor, for example, may be described as: a processor including a device discovery unit, a list retrieving unit, a protocol detection unit, a connection establishing unit, an information acquisition unit, a data transmission unit and a data interaction unit. Here, the names of these units do not in some cases constitute limitations to such units themselves. For example, the device discovery unit may also be described as “a unit configured to extract, in response to a broadcast packet sent by a Bluetooth device, from the broadcast packet a device identifier of the Bluetooth device”.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present disclosure are examples.

1. A method for data interaction, the method comprising:
extracting, in response to a broadcast packet sent by a target Bluetooth device, from the broadcast packet a target device identifier of the target Bluetooth device;
retrieving the target device identifier in a preset device list, the device list comprising device identifiers of connectable Bluetooth devices;
in response to determining that the target device identifier is included in the device list, determining whether a preset application protocol exists in the target Bluetooth device;
in response to determining that the preset application protocol exists in the target Bluetooth device, establishing a Bluetooth transmission connection based on the application protocol;
acquiring, based on the target device identifier, a H5 module and configuration parameters corresponding to the target Bluetooth device, the H5 module being pre-set with an interface specification of an IoT platform and a parsing algorithm preset by a manufacturer, and the configuration parameters characterizing parameters of the preset application protocol pre-determined by the manufacturer;
receiving, based on the configuration parameters, to-be-parsed data sent by the target Bluetooth device, and transmitting the to-be-parsed data to the H5 module by unvarnished transmission; and
performing following steps through the H5 module: parsing the to-be-parsed data using the parsing algorithm to obtain parsed data; and sending the parsed data to the IoT platform based on the interface specification of the IoT platform.

2. The method according to claim 1, wherein the method further comprises:
in response to determining that the preset application protocol does not exist in the target Bluetooth device, acquiring an application protocol of the IoT platform; and
sending the application protocol of the IoT platform to the target Bluetooth device, and establishing a Bluetooth transmission connection based on the application protocol of the IoT platform.

3. The method according to claim 1, wherein the H5 module and the configuration parameters are acquired via following steps:
sending the target device identifier to a server of the IoT platform, to instruct the server to determine the H5 module and the configuration parameters corresponding to the target device identifier based on a preset corresponding relationship between the device identifier and the H5 module and the configuration parameters; and
receiving the H5 module and the configuration parameters sent by the server.

4. The method according to claim 1, wherein the H5 module further comprises an interface specification of a manufacturer server of the manufacturer, and a data processing algorithm is pre-provided in the manufacturer server; and
the method further comprises performing following steps through the H5 module: sending the parsed data to the manufacturer server based on the interface specification of the manufacturer server, to instruct the manufacturer server to call the data processing algorithm to process the parsed data; receiving processed data sent by the manufacturer server; and sending the processed data to the IoT platform.

5. The method according to claim 1, wherein the configuration parameters comprise a device access mode; and
the method further comprises performing following steps through the H5 module: in response to determining that the device access mode is a connection-oriented access mode, receiving downlink data sent by the IoT platform, and transmitting the downlink data to the Bluetooth device.

6. An apparatus for data interaction, the apparatus comprising:
one or more processors; and
a memory storing one or more programs;
wherein the one or more programs, when executed by the one or more processors, cause the one or more processors to perform operations, the operations comprising:
extracting, in response to a broadcast packet sent by a target Bluetooth device, from the broadcast packet a target device identifier of the target Bluetooth device;
retrieving the target device identifier in a preset device list, the device list comprising device identifiers of connectable Bluetooth devices;
determining whether a preset application protocol exists in the target Bluetooth device, in response to determining that the target device identifier is included in the device list;
establishing a Bluetooth transmission connection based on the application protocol, in response to determining that the preset application protocol exists in the target Bluetooth device;
acquiring, based on the target device identifier, a H5 module and configuration parameters corresponding to the target Bluetooth device, the H5 module being pre-set with an interface specification of an IoT platform and a parsing algorithm preset by a manufacturer, and the configuration parameters characterizing parameters of the preset application protocol pre-determined by the manufacturer;
receiving, based on the configuration parameters, to-be-parsed data sent by the target Bluetooth device, and transmitting the to-be-parsed data to the H5 module by unvarnished transmission; and
performing following steps through the H5 module: parsing the to-be-parsed data using the parsing algorithm to obtain parsed data; and sending the parsed data to the IoT platform based on the interface specification of the IoT platform.

7. The apparatus according to claim 6, wherein the operations further comprise:
acquiring an application protocol of the IoT platform, in response to determining that the preset application protocol does not exist in the target Bluetooth device; and
sending the application protocol of the IoT platform to the target Bluetooth device, and establishing a Bluetooth transmission connection based on the application protocol of the IoT platform.

8. The apparatus according to claim 6, wherein the H5 module and the configuration parameters are acquired via following steps:
sending the target device identifier to a server of the IoT platform, to instruct the server to determine the H5 module and the configuration parameters corresponding to the target device identifier based on a preset corresponding relationship between the device identifier and the H5 module and the configuration parameters; and
receiving the H5 module and the configuration parameters sent by the server.

9. The apparatus according to claim 6, wherein the H5 module further comprises an interface specification of a manufacturer server of the manufacturer, and a data processing algorithm is pre-provided in the manufacturer server; and
the operations further comprise performing following steps through the H5 module: sending the parsed data to the manufacturer server based on the interface specification of the manufacturer server, to instruct the manufacturer server to call the data processing algorithm to process the parsed data; receiving processed data sent by the manufacturer server; and sending the processed data to the IoT platform.

10. The apparatus according to claim 6, wherein the configuration parameters comprise a device access mode; and
the operations further comprise performing following steps through the H5 module: in response to determining that the device access mode is a connection-oriented access mode, receiving downlink data sent by the IoT platform, and transmitting the downlink data to the Bluetooth device.

11. (canceled)

12. A non-transitory computer readable medium, storing a computer program thereon, wherein, the program, when executed by a processor, implements operations, the operations comprise:
extracting, in response to a broadcast packet sent by a target Bluetooth device, from the broadcast packet a target device identifier of the target Bluetooth device;
retrieving the target device identifier in a preset device list, the device list comprising device identifiers of connectable Bluetooth devices;
in response to determining that the target device identifier is included in the device list, determining whether a preset application protocol exists in the target Bluetooth device;
in response to determining that the preset application protocol exists in the target Bluetooth device, establishing a Bluetooth transmission connection based on the application protocol;
acquiring, based on the target device identifier, a H5 module and configuration parameters corresponding to the target Bluetooth device, the H5 module being pre-set with an interface specification of an IoT platform and a parsing algorithm preset by a manufacturer, and the configuration parameters characterizing parameters of the preset application protocol pre-determined by the manufacturer;
receiving, based on the configuration parameters, to-be-parsed data sent by the target Bluetooth device, and transmitting the to-be-parsed data to the H5 module by unvarnished transmission; and
performing following steps through the H5 module: parsing the to-be-parsed data using the parsing algorithm to obtain parsed data; and sending the parsed data to the IoT platform based on the interface specification of the IoT platform.

13. The non-transitory computer readable medium according to claim 12, wherein the operations further comprise:
in response to determining that the preset application protocol does not exist in the target Bluetooth device, acquiring an application protocol of the IoT platform; and
sending the application protocol of the IoT platform to the target Bluetooth device, and establishing a Bluetooth transmission connection based on the application protocol of the IoT platform.

14. The non-transitory computer readable medium according to claim 12, wherein the H5 module and the configuration parameters are acquired via following steps:
sending the target device identifier to a server of the IoT platform, to instruct the server to determine the H5 module and the configuration parameters corresponding to the target device identifier based on a preset corresponding relationship between the device identifier and the H5 module and the configuration parameters; and
receiving the H5 module and the configuration parameters sent by the server.

15. The non-transitory computer readable medium according to claim 12, wherein the H5 module further comprises an interface specification of a manufacturer server of the manufacturer, and a data processing algorithm is pre-provided in the manufacturer server; and
the operations further comprise performing following steps through the H5 module: sending the parsed data to the manufacturer server based on the interface specification of the manufacturer server, to instruct the manufacturer server to call the data processing algorithm to process the parsed data; receiving processed data sent by the manufacturer server; and sending the processed data to the IoT platform.

16. The non-transitory computer readable medium according to claim 12, wherein the configuration parameters comprise a device access mode; and
the operations further comprise performing following steps through the H5 module: in response to determining that the device access mode is a connection-oriented access mode, receiving downlink data sent by the IoT platform, and transmitting the downlink data to the Bluetooth device.
